(19) United States
(12) Patent Application Publication
(10) Pub. No.: US 2006/0224827 A1
(43) Pub. Date: Oct. 5, 2006

(54) Disk array subsystem including disk array with redundancy

(76) Inventors: Susumu Hirofuji, Tokyo (JP); Masao Sakitani, Tachikawa-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/389,306

(22) Filed: Mar. 27, 2006

(30) Foreign Application Priority Data
Mar. 29, 2005 (JP) 2005-095359

(51) Int. Cl. G06F 12/16

(52) U.S. Cl. 711/114; 714/2

(57) ABSTRACT

A disk array subsystem includes a disk array with redundancy, a spare disk drive and an array controller. The array controller causes a host to recognize the disk array as a first logical unit having a single storage area. When one of a plurality of disk drives that compose the disk array fails, the array controller replaces the failed disk drive with the spare disk drive. The array controller causes the host to recognize the failed disk drive as a second logical unit other than the first logical unit.

### CROSS-REFERENCE TO RELATED APPLICATIONS

This application is based upon and claims the benefit of priority from prior Japanese Patent Application No. 2005-095359, filed Mar. 29, 2005, the entire contents of which are incorporated herein by reference.

### BACKGROUND OF THE INVENTION

1. Field of the Invention

The present invention relates to a disk array subsystem including a disk array with redundancy, which is composed of a plurality of disk drives, and an array controller that controls the disk array. More specifically, the invention relates to a disk array subsystem favorable for accessing one of disk drives independently from the other disk drives when the one of the disk drives fails.

2. Description of the Related Art

In general, a disk array subsystem includes a disk array with redundancy and an array controller that controls the disk array. The disk array is composed of a plurality of disk drives such as a plurality of hard disk drives (HDD). Assume here that one of the HDDs has failed. The failed HDD is replaced with another normal HDD, as described in, for example, Jpn. Pat. Appln. KOKAI Publication No. 11-85412 (hereinafter referred to as a prior art document).

The array controller restores data of the failed HDD from data of HDDs composing the disk array, excluding the failed HDD. The array controller stores the restored data in the normal HDD. The data of the failed HDD is thus restored to the normal HDD. Consequently, the disk array subsystem can continue to operate in the same way as before the HDD fails.

According to the above prior art document, when one of the HDDs that compose the disk array fails, data of the failed HDD can be restored from data of the remaining HDDs. It is general that the failed HDD cannot be used by a user for its investigation and repair. In other words, it is general that the failed HDD is physically separated from the disk array subsystem and relocated in an environment where it can be operated alone.

### BRIEF SUMMARY OF THE INVENTION

According to an embodiment of the present invention, there is provided a disk array subsystem that is accessible by a host. The disk array subsystem comprises a disk array with redundancy, which is composed of a plurality of disk drives, a spare disk drive with which one of the disk drives is replaced when the one of the disk drives fails, and an array controller which controls the disk array. The array controller includes replacement means for replacing the failed disk drive with the spare disk drive, and management means for causing the host to recognize the disk array as a first logical unit having a single storage area. The management means causes the host to recognize the failed disk drive as a second logical unit other than the first logical unit.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a configuration of a disk array subsystem according to an embodiment of the present invention;

FIG. 2 is a chart showing an example of management information used to manage HDDs of the disk array subsystem shown in FIG. 1;

FIG. 3 is a chart showing an example of logical unit configuration information that represents a configuration of a logical unit of the disk array subsystem shown in FIG. 1;

FIG. 4 is a flowchart showing a procedure that a microprocessor performs when an HDD fails in the disk array subsystem according to the embodiment of the present invention;

FIG. 5 is a diagram showing an example of a configuration of a changed logical unit and an example of a configuration of a new logical unit in the disk array subsystem according to the embodiment of the present invention;

FIG. 6A is a chart showing an example of logical unit configuration information updated when the configuration of the logical unit is changed in the disk array subsystem according to the embodiment of the present invention;

FIG. 6B is a chart showing an example of logical unit configuration information that represents the configuration of the new logical unit in the disk array subsystem according to the embodiment of the present invention;

FIG. 7 is a block diagram of a disk array subsystem according to a first modification to the disk array subsystem according to the embodiment of the present invention; and

FIG. 8 is a block diagram of a disk array subsystem according to a second modification to the disk array subsystem according to the embodiment of the present invention.

### DETAILED DESCRIPTION OF THE INVENTION

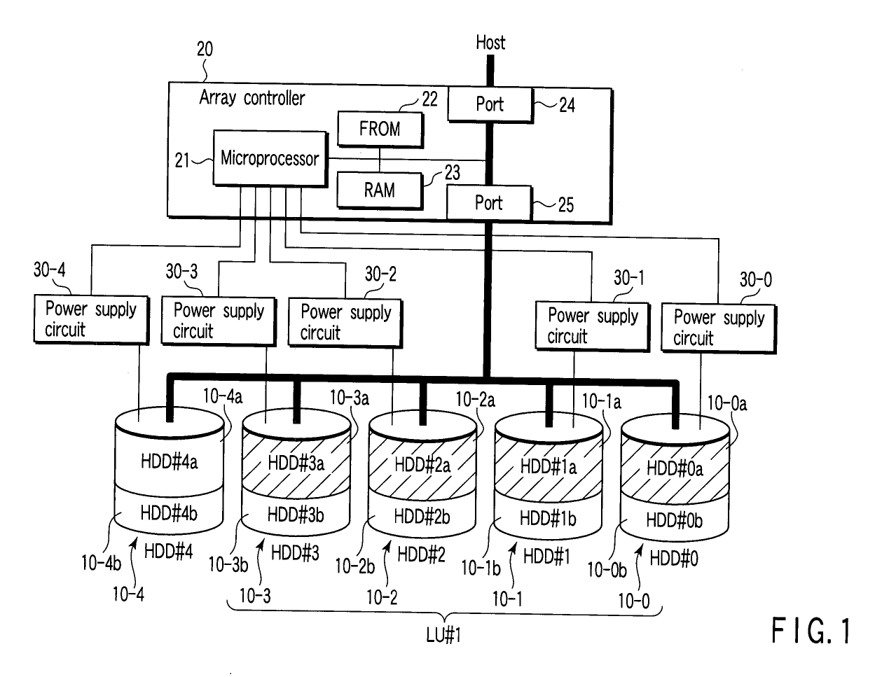

A disk array subsystem according to an embodiment of the present invention will be described with reference to the accompanying drawings. FIG. 1 is a block diagram showing a configuration of the disk array subsystem. The disk array subsystem includes a plurality of disk drives, e.g., five hard disk drives (HDD) 10-0 to 10-4, an array controller (disk array controller) 20 and power supply circuits 30-0 to 30-4. The array controller 20 controls a disk array with redundancy. This disk array is composed of, e.g., HDDs 10-0 to 10-3 of the five hard disk drives 10-0 to 10-4.

In the present embodiment, the disk array is recognized as a logical unit LU#1 by a host (host computer) not shown. When the logical unit LU#1 is composed of HDDs 10-0 to 10-3 as described above, the remaining HDD 10-4 is used in place of one of the HDDs 10-0 to 10-3 when the one of the HDDs fails. This HDD 10-4 is called a hot spare HDD (HSHDD). The power supply circuits 30-0 to 30-4 control their respective power supplies of the HDDs 10-0 to 10-4 under the control of the array controller 20.

The storage areas of the HDDs 10-0 to 10-4 are divided into data areas 10-0a (HDD#0a) to 10-4a (HDD#4a) and management areas 10-0b (HDD#0b) to 10-4b (HDD#4b) to mange these data and management areas separately. The data areas 10-0a (HDD#0a) to 10-4a (HDD#4a) are used to store data (user data), while the management areas 10-0b (HDD#0b) to 10-4b (HDD#4b) are used to store management information for managing the HDDs 10-0 to 10-4.

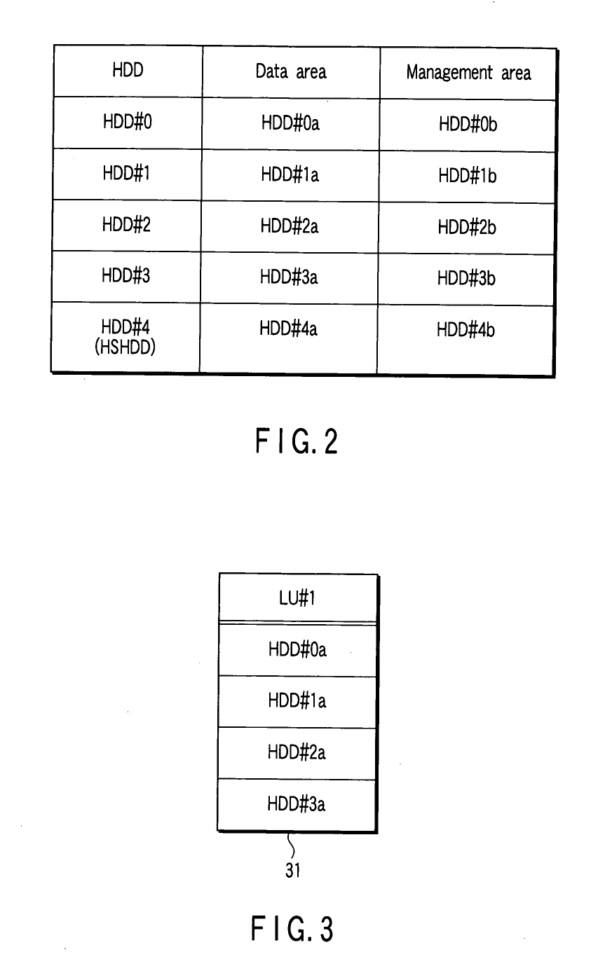

The logical unit LU#1 is composed of data areas 10-0a (HDD#0a) to 10-3a (HDD#3a) of HDDs 10-0 to 10-3. FIG. 2 shows an example of the management information described above. More specifically, the management information is used to manage the data areas 10-0a to 10-4a of HDDs 10-0 to 10-4 and the management areas 10-0b to 10-4b of HDDs 10-0 to 10-4. The management information is stored in the management areas 10-0b to 10-4b or a flash ROM (FROM) 22, which will be described later, in the form shown in FIG. 2.

FIG. 3 shows an example of logical unit configuration information 31 that represents the configuration of the logical unit LU#1. The logical unit configuration information 31 is stored in the management areas 10-0b to 10-4b or a flash ROM 22 in the form shown in FIG. 3. The logical unit configuration information 31 indicates that the logical unit LU#1, which can be recognized as a single storage area by the host, is composed of data areas 10-0a (HDD#0a) to 10-3a (HDD#3a) of HDDs 10-0 to 10-3.

Referring again to FIG. 1, the array controller 20 includes a microprocessor 21, a flash ROM (FROM) 22, a RAM 23 and ports 24 and 25. The microprocessor 21 functions as a main controller of the array controller 20. The FROM 22 stores control programs to be executed by the microprocessor 21 and various items of management information. The control programs are used to control the disk array by the array controller 20 (microprocessor 21). The storage area of the RAM 23 provides a work area of the microprocessor 21 and the like. The array controller 20 is connected to the host via the port 24 and also connected to the HDDs 10-0 to 10-4 via a small computer system interface (SCSI) bus or the like.

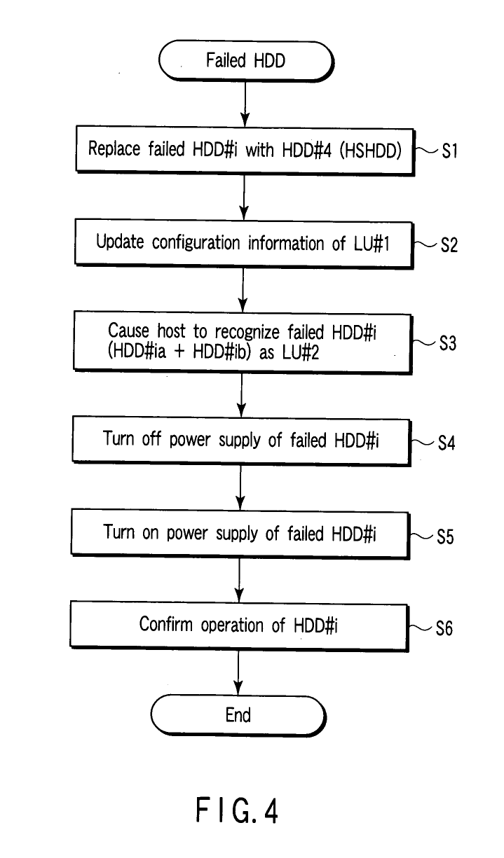

An operation of the disk array subsystem shown in FIG. 1 will be described with reference to the flowchart shown in FIG. 4. Assume here that one of HDDs 10-0 (HDD#0) to 10-3 (HDD#3) which compose the logical unit LU#1, e.g., the HDD 10-0 (HDD#0) has failed. The failed HDD 10-0 (HDD#0) is referred to as HDD 10-i (HDD#i). The failed HDD#i (=HDD#0) is detected by the microprocessor 2 of the array controller 20.

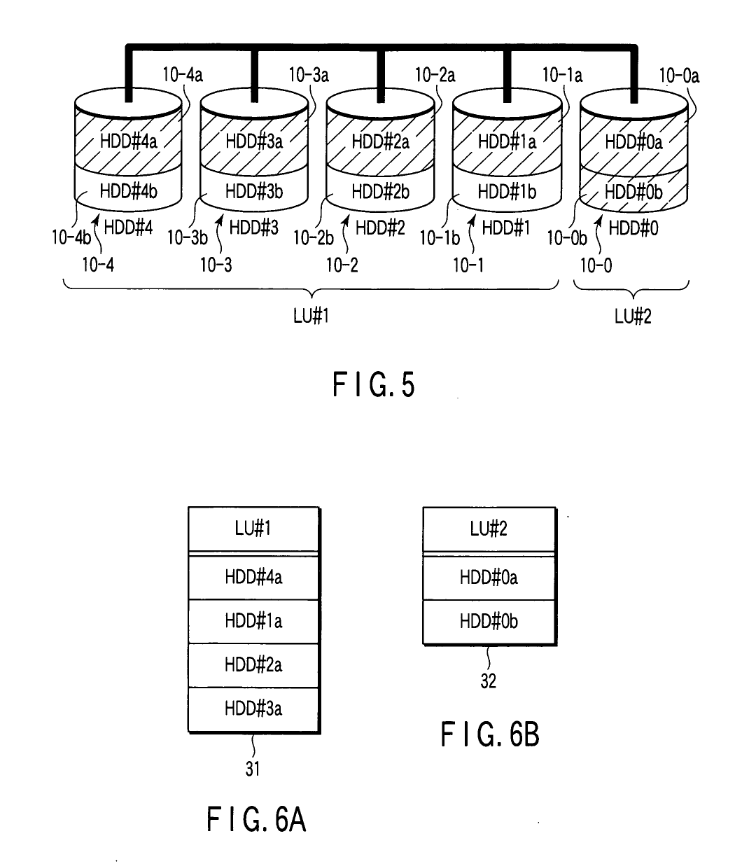

When the microprocessor 21 detects the failed HDD#i (=HDD#0), it replaces the HDD#1 (=HDD#0) with the HDD 10-4 (HDD#4) (HSHDD) (step S1). The step S1 is executed as follows. First, data of the failed HDD#i (=HDD#0) is restored from data of the remaining HDD#1 to HDD#3, using the redundancy of the disk array. The restored data is stored in the HDD#4 (HSHDD). In step S1, the logical unit LU#1 (disk array) changes from a configuration of HDD#0 to HDD#3 shown in FIG. 1 to that of HDD#1 to HDD#4 shown in FIG. 5.

The microprocessor 21 updates the configuration information 31 of the logical unit LU#1 shown in FIG. 3 to reflect the configuration shown in FIG. 5 (step S2). FIG. 6A shows the updated configuration information 31 of the logical unit LU#1. As is apparent from FIG. 6A, the updated configuration information 31 indicates that the logical unit LU#1 is composed of data areas HDD#1a to HDD#4a of HDD#1 to HDD#4. In step S2, the microprocessor 21 notifies the host of the updated configuration information 31 to cause the host to recognize that the logical unit LU#1 is composed of data areas HDD#1a to HDD#4a of HDD#1 to HDD#4.

The microprocessor 21 causes the host to recognize all of the areas (data area HDD#0a and management area HDD#0b) of the failed HDD#i (=HDD#0) as a logical unit LU#2 other than the logical unit LU#1 (step S3). To do so, the microprocessor 21 notifies the host of configuration information 32 in the form shown in FIG. 6B as configuration information of the logical unit LU#2. Thus, the host can recognize that the logical unit LU#2 is composed of the data area HDD#0a and management area HDD#0b of the failed HDD#i (=HDD#0). With this recognition, the host not only can read/write data from/to the data area HDD#0a of the failed HDD#i (=HDD#0) but also can read/write data from/to the management area HDD#0b thereof. In other words, the host can rewrite (or erase) the data stored in all of the areas of the failed HDD#i (=HDD#0). This data rewrite (data erase) can also be performed by the array controller 20 itself.

The microprocessor 21 turns off the power supply of the failed HDD#i (=HDD#0) independently of the other HDDs through a power supply circuit 30-i (30-0) corresponding to the failed HDD#i (=HDD#0) (step S4). Subsequent to that, the microprocessor 21 turns on the power supply of the failed HDD#i (=HDD#0) through the power supply circuit 30-i (30-0) (step S5). Turning off and turning on the power supply of the failed HDD#i (=HDD#0) continuously, the microprocessor 21 reboots and initializes the failed HDD#i (=HDD#0). Then, the microprocessor 21 confirms the operation of the failed HDD#i (=HDD#0) through the port 25 (step S6). In place of the host, the microprocessor 21 can erase data of the failed HDD#i (=HDD#0).

As described above, the microprocessor 21 (array controller 20) can cause the host to recognize the failed HDD#i (=HDD#0) which is replaced with the HDD#4 (HSHDD), as the logical unit LU#2. Thus, the microprocessor 21 continues to operate the logical unit LU#1 and allows the host to access the failed HDD#i (=HDD#0) without physically separating the failed HDD#i (=HDD#0) from the disk array subsystem. This access allows the host to investigate or repair the failed HDD#i (=HDD#0). If the failure of the failed HDD#i (=HDD#0) is caused by a disk medium included in the HDD#i (=HDD#0), the HDD#i (=HDD#0) includes an accessible area. In the present embodiment, this area can be accessed by the host.

Furthermore, the microprocessor 21 (array controller 20) can turn on/off the power supply of the failed HDD#i (=HDD#0) independently of the HDDs that compose of the logical unit LU#1 under operation to reboot the failed HDD#i (=HDD#0). The array controller 20 can thus confirm whether the failed HDD#i (=HDD#0) can be operated. If the failed HDD#i (=HDD#0) is operated, the failed HDD#i (=HDD#0) influences the other HDDs under operation. This influence can be reduced to a minimum.

[First Modification]

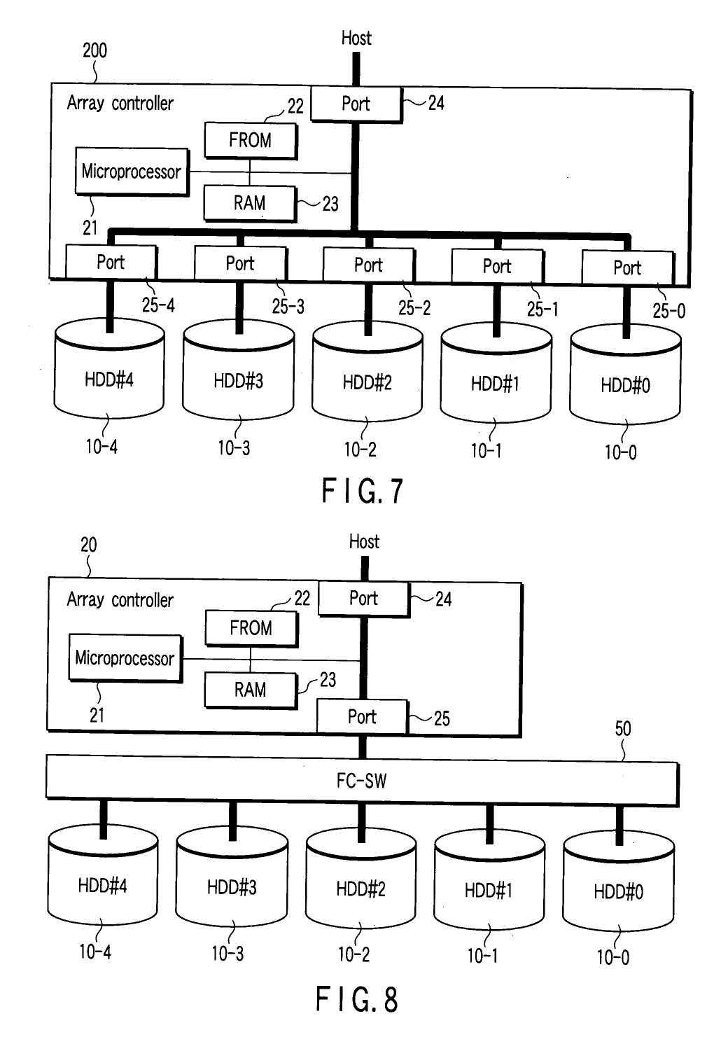

A first modification to the above embodiment will be described with reference to FIG. 7. FIG. 7 is a block diagram showing a disk array subsystem according to the first modification. In FIG. 7, the same components as those shown in FIG. 1 are denoted by the same reference numeral. The feature of the disk array subsystem shown in FIG. 7 lies in that a array controller 200 is used in place of the array controller 20 shown in FIG. 1. The array controller 200 includes ports 25-0 to 25-4 that correspond to the port 25 shown in FIG. 1. The array controller 20 is connected to HDDs 10-0 (HDD#0) to 10-4 (HDD#4) via their respective ports 25-0 to 25-4 by, e.g., a Serial AT Attachment (SATA) interface or an Integrated Device Electronics (IDE) interface.

In the disk array subsystem shown in FIG. 7, a data transfer path is provided between the array controller 20 and each of the HDDs 10-0 (HDD#0) to 10-4 (HDD#4). When the array controller 20 reboots the failed HDD#i (=HDD#0) to gain access to the HDD#i (=HDD#0), the influence of the failed HDD#i (=HDD#0) upon the other normal HDDs under operation can be lessened.

[Second Modification]

A second modification to the above embodiment will be described with reference to FIG. 8. FIG. 8 is a block diagram showing a disk array subsystem according to the second modification. In FIG. 8, the same components as those shown in FIG. 1 are denoted by the same reference numeral. The feature of the disk array subsystem shown in FIG. 8 lies in that a fibre channel switch (FC-SW) 50 is provided between the port 25 of the array controller 20 and the HDD#1 to HDD#4.

In the disk array subsystem shown in FIG. 8, the port 25 is connected to each of the HDD#1 to HDD#4 through the switch 50. In this subsystem, too, when the array controller 20 reboots the failed HDD#i (=HDD#0) to gain access to the HDD#i (=HDD#0), the influence of the failed HDD#i (=HDD#0) upon the other normal HDDs under operation can be lessened.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A disk array subsystem that is accessible by a host, comprising:
a disk array with redundancy, which is composed of a plurality of disk drives;
a spare disk drive with which one of the disk drives is replaced when the one of the disk drives fails; and
an array controller which controls the disk array, the array controller including:
replacement means for replacing the failed disk drive with the spare disk drive; and
management means for causing the host to recognize the disk array as a first logical unit having a single storage area and causing the host to recognize the failed disk drive as a second logical unit other than the first logical unit.

2. The disk array subsystem according to claim 1, further comprising a power supply circuit that is provided for each of the disk drives and the spare disk drive to turn on/off a corresponding disk drive, and
wherein the array controller includes confirmation means for confirming an operation of the failed disk drive, and the confirmation means first turns off a power supply of the failed disk drive through a power supply circuit corresponding to the failed disk drive and then turns on the power supply to initialize the failed disk drive and confirm the operation of the failed disk drive.

3. The disk array subsystem according to claim 1, wherein the management means divides a storage area of each of the disk drives and the spare disk drive into a data area used to store user data and a management area used to store system management information to manage the data area and the management area separately, and causes the host to recognize all data areas of the disk drives as the first logical unit.

4. The disk array subsystem according to claim 3, wherein when the failed disk drive is replaced with the spare disk drive, the management means causes the host to recognize all data areas of the disk drives and the spare disk drive excluding the failed disk drive as the first logical unit, and causes the host to recognize both a data area and a management area of the failed disk drive as the second logical unit.

5. The disk array subsystem according to claim 4, wherein the management means notifies the host of first configuration information indicating storage areas of the first logical unit and second configuration information indicating storage areas of the second logical unit to cause the host to recognize the storage areas of the first logical unit and the storage areas of the second logical unit.

6. The disk array subsystem according to claim 1, wherein the array controller includes:
a first port through which the host is connected to the array controller; and
a plurality of second ports through which the disk drives and the spare disk drive are each connected to the array controller.

7. The disk array subsystem according to claim 1, wherein the array controller includes:
a fibre channel switch which provides a data transfer path between each of the disk drives and the spare disk drive and the array controller;
a first port through which the host is connected to the array controller; and
a second port through which the data transfer path is connected to the array controller.

8. The disk array subsystem according to claim 1, wherein the array controller includes erasure means for erasing data of a data area and a management area of the failed disk drive.

9. A method of controlling a disk array with redundancy, which is composed of a plurality of disk drives, the disk array being recognized as a first logical unit having a single storage area by a host, the method comprising:
replacing one of the disk drives with a spare disk drive when the one of the disk drives fails; and
causing the host to recognize the failed disk drive as a second logical unit other than the first logical unit.

10. The method according to claim 9, further comprising:
turning off a power supply of the failed disk drive through a power supply circuit provided for the failed disk drive;
turning on the power supply, which is turned off, to initialize the failed disk drive; and
confirming an operation of the initialized disk drive.

11. The method according to claim 9, wherein:
a storage area of each of the disk drives and the spare disk drive is divided into a data area used to store user data and a management area used to store system management information to manage the data area and the management area separately; and
the first logical unit is composed of all data areas of the disk drives.

12. The method according to claim 11, further comprising:
causing the host to recognize all data areas of the disk drives and the spare disk drive excluding the failed disk drive as the first logical unit; and
causing the host to recognize both a data area and a management area of the failed disk drive as the second logical unit.

13. A computer program product used to control a disk array with redundancy, which is composed of a plurality of disk drives, the disk array being recognized as a first logical unit having a single storage area by a host, the computer program product comprising:
computer-readable program code means for causing a computer to replace one of the disk drives with a spare disk drive when the one of the disk drives fails; and
computer-readable program code means for causing the computer to cause the host to recognize the failed disk drive as a second logical unit other than the first logical unit.

14. The computer program product according to claim 13, further comprising:
computer-readable program code means for causing the computer to turn off a power supply of the failed disk drive through a power supply circuit provided for the failed disk drive;
computer-readable program code means for causing the computer to turn on the power supply, which is turned off, to initialize the failed disk drive; and
computer-readable program code means for causing the computer to confirm an operation of the initialized disk drive.

15. The computer program product according to claim 13, wherein:
a storage area of each of the disk drives and the spare disk drive is divided into a data area used to store user data and a management area used to store system management information to manage the data area and the management area separately; and
the first logical unit is composed of all data areas of the disk drives.

16. The computer program product according to claim 15, further comprising:
computer-readable program code means for causing the computer to cause the host to recognize all data areas of the disk drives and the spare disk drive excluding the failed disk drive as the first logical unit; and
computer-readable program code means for causing the computer to cause the host to recognize both a data area and a management area of the failed disk drive as the second logical unit.
